(19) United States
(12) Patent Application Publication
(10) Pub. No.: US 2007/0261658 A1
(43) Pub. Date: Nov. 15, 2007

(54) Piston For Internal-Combustion Engine And Combination Of Piston And Piston Ring For Internal-Combustion Engine

(75) Inventors: Tomoaki Abe, Aichi (JP); Hideshi Hitosugi, Saitama (JP)

Correspondence Address: YOUNG & THOMPSON, 745 SOUTH 23RD STREET, 2ND FLOOR, ARLINGTON, VA, 22202, US

(73) Assignee: Nippon Piston Ring Co., Ltd., Saitama-Shi (JP)

(21) Appl. No.: 11/667,564

(22) PCT Filed: Nov. 22, 2005
(86) PCT No.: PCT/JP05/21436

§ 371 Date: Jun. 13, 2007

(30) Foreign Application Priority Data
Nov. 22, 2004 (JP) 2004-337856

(51) Int. Cl. F02F 3/00; F02F 5/00

(52) U.S. Cl. 123/193.6; 277/457

(57) ABSTRACT

A piston for an internal-combustion engine includes a through-hole communicating with the inner space of the piston formed in an oil-ring groove into which an oil ring is fitted and a through-hole connected with a second-ring groove, the through-hole having an opening spreading from the lower portion of the bottom of the second-ring groove in a top-to-bottom direction of the piston to the lower surface of the second-ring groove and linearly extending to the inner space of the piston; and a combination of the piston and piston rings of the three-ring type for an internal-combustion engine, the end gaps of compression rings among the piston rings being set in a predetermined range.

### TECHNICAL FIELD

The present invention relates to pistons for internal-combustion engines and combinations of pistons and piston rings for internal-combustion engines capable of reducing consumption of lubricating oil when pressure inside combustion chambers becomes negative, for example, during intake strokes of the engines or during use of engine braking.

### BACKGROUND ART

Recently, there has been a strong need for reducing frictional resistance between piston rings and cylinders in order to improve fuel efficiency of internal-combustion engines. A known automobile engine includes pistons of the three-ring type as shown in FIG. 9(a), which is a schematic longitudinal partial sectional view of a principal part of the pistons.

Such a piston of the three-ring type has a first-ring groove 2, a second-ring groove 3, and an oil-ring groove 4 disposed in this order from the top to bottom on an outer periphery of a top portion 1 thereof. Piston rings are fitted into the ring grooves before the piston is assembled into a cylinder 11. In order to attain an object of improving fuel efficiency of automobile engines, tension and widths h1 (FIG. 12) of the piston rings for the piston of the three-ring type are reduced so as to reduce the friction.

As shown in FIGS. 9(a) and 9(b), the piston of the three-ring type further includes a second land 5 disposed above the second-ring groove 3, a third land 6 disposed under the second-ring groove 3, and an oil-drain hole 8 for returning lubricating oil scraped off by an oil ring 14 to an oil pan. In FIG. 9(a), reference numerals 1, 7 and 10A denote the top portion, the skirt portion and a top-to-bottom direction of the piston, respectively. This piston of the three-ring type scrapes off excess lubricating oil adhering to the cylinder wall by using the oil ring 14 during reciprocation in the cylinder 11 in a moving direction 10H, and returns the excess lubricating oil to the oil pan through the oil-drain hole 8 connected with the oil ring 14.

However, in the case of the piston having only the oil-drain hole 8 connected with the oil ring 14, it is difficult to reduce the consumption of the lubricating oil to a required level by only improving the piston rings when the engine is operated according to an acceleration-deceleration driving pattern where the engine rotating at a high speed is decelerated using strong engine braking, and then is accelerated. Here, the first ring mainly functions as a compression ring that ensures a gas-sealing property, and the second ring functions as an oil controller while assisting the gas-sealing function of the first ring.

Therefore, control of consumption of lubricating oil and volume of blow-by gas by improving engine pistons has been proposed (Patent Documents 1 to 7).

Patent Document 1 proposes a piston having a hole communicating with the interior of the piston formed in the bottom of a ring groove into which a compression ring is fitted. Moreover, Patent Document 2 describes a piston having a hole communicating with the interior of the piston formed in the bottom of a second-ring groove, the hole functioning as a blow-by-gas path for guiding unburned remaining gas to a crankcase. Patent Document 3 proposes a piston for a two-stroke engine having a hole communicating with the interior of the piston formed in the bottom of a second-ring groove, the piston capable of preventing blow-by of supercharged air from a scavenging port to a crankcase and preventing outflow of oil in the crankcase to the scavenging port while appropriately lubricating the piston ring.

Patent Document 4 proposes a piston for a slant engine to be mounted obliquely with respect to a vertical direction, the piston preventing lubricating oil that accumulates in lower portions of a cylinder and the piston due to gravity from entering an annular space between the cylinder and the piston and from being pushed out to a combustion chamber during operation of the engine.

Patent Documents 5 and 6 each propose a piston having a hole in a land portion immediately above an oil-ring groove, the hole serving as an oil-bypass hole guiding lubricating oil to the inner space of the piston, and having no oil-bypass hole in a second-ring groove.

Moreover, Patent Document 7 describes a piston having a through-hole communicating with the interior of the piston formed in the bottom of a second-ring groove and an offset groove extending all through in the lower surface of the second-ring groove in a radial direction of the piston so as to communicate with the hole. This piston can reduce the pressure around a second land, and reduce oil consumption.

Patent Document 1: Japanese Unexamined Utility Model Registration Application Publication No. 50-43104

Patent Document 2: Japanese Unexamined Patent Application Publication No. 55-161940

Patent Document 3: Japanese Unexamined Utility Model Registration Application Publication No. 5-7951

Patent Document 4: Japanese Unexamined Patent Application Publication No. 5-71420

Patent Document 5: Japanese Unexamined Patent Application Publication No. 7-279752

Patent Document 6: Japanese Unexamined Utility Model Registration Application Publication No. 56-122748

Patent Document 7: Japanese Unexamined Utility Model Registration Application Publication No. 6-14455

### DISCLOSURE OF INVENTION

### Problems to be Solved by the Invention

However, the pistons described in Patent Documents 1 to 5 cannot sufficiently control consumption of lubricating oil when the pressure inside the combustion chambers becomes negative, for example, during intake strokes of the engines or during use of engine braking.

The pistons described in Patent Documents 6 and 7 can reduce the consumption of the lubricating oil when the pressure inside the combustion chamber becomes negative, for example, during intake strokes of the engines or during use of engine braking. Patent Document 6 is characterized in that a vent hole communicating with the interior of the piston is formed in the land portion immediately above the oil-ring groove. This piston having the vent hole in the land portion can discharge the lubricating oil, which was not scraped off by an oil ring, from the vent hole while the lubricating oil passes across the land portion. However, only the lubricating oil that has reached the land portion can be discharged.

The piston described in Patent Document 7 is characterized in that a through-hole is formed so as to pass between the bottom surface of the second-ring groove and a surface of the piston facing the crankcase. In FIG. 5 of Patent Document 7, the offset groove extending in the lower surface of the second-ring groove in a radial direction so as to communicate with the through-hole is illustrated. However, in order to form the through-hole and the offset groove shown in the drawing, the through-hole and the offset groove are separately machined. Thus, the number of machining steps and the costs for machining are increased.

At the present time, reductions in friction between piston rings and cylinder bores are required, and a total tension ratio, which is determined by dividing the total tension of compression rings and oil rings by the diameter of the piston rings, is required to be in a significantly small range of 0.2 to 0.6 N/mm. Thus, reductions in tension and widths h1 and modifications in shape of sliding surfaces of piston rings have become strongly required for reducing the friction of the piston rings. Furthermore, in order to achieve cleaner and safer combustion, engines are optimally and efficiently controlled using, for example, a variable valve timing mechanism. Due to the negative pressure generated by deceleration using normal engine braking and, furthermore, complicated valve mechanisms as described above, pistons are severely used also in a negative-pressure environment at the present time.

Problems of pistons of the three-ring type will now be described with reference to FIG. 9(b).

This drawing schematically illustrates a state at a first half of an intake stroke during deceleration using engine braking. In the case of deceleration using engine braking in a four-stroke gasoline engine, the amount of inhaled air is extremely small. Therefore, the pressure inside the combustion chamber during a period from the intake stroke to a predetermined point in a compression stroke and during a second half of an expansion stroke becomes lower than atmospheric pressure (8 to 17.3 kPa in absolute pressure inside an intake pipe), i.e., negative (see FIG. 8). The interior of the intake pipe approaches a vacuum as the absolute pressure thereof approaches zero. In FIG. 9(b), the piston is accelerated downward, and a second ring 13 and the oil ring 14 are in contact with the upper surfaces of the corresponding ring grooves by action of both the inertial force and the force generated by the negative pressure inside the combustion chamber.

In such a state, according to the degree of the negative pressure inside the combustion chamber, the lubricating oil around the first ring is sucked into the combustion chamber via a first land. When the negative pressure inside the combustion chamber also acts on a space facing the second land 5, the lubricating oil located around the second ring 13, the second-ring groove 3, and the third land 6 is sucked to a position of the second land 5, resulting in an increase in consumption of the lubricating oil. Furthermore, when the negative pressure inside the combustion chamber also acts on a space facing the third land 6, the lubricating oil around the oil ring 14 is sucked to a position of the third land 6. Such an oil-rising phenomenon becomes pronounced as the pressure inside the combustion chamber becomes more negative, and the consumption of the lubricating oil is increased.

Thus, it is difficult for the existing pistons of the three-ring type to sufficiently control the consumption of the lubricating oil when the pressure inside the combustion chambers becomes negative, for example, during intake strokes of the engines or during use of engine braking.

Accordingly, an object of the present invention is to provide a piston for an internal-combustion engine and a combination of a piston and three piston rings, including two compression rings and an oil ring, for an internal-combustion engine capable of sufficiently controlling consumption of lubricating oil when the pressure inside a combustion chamber becomes negative, for example, during intake strokes of the engine or during use of engine braking.

### Means of Solving the Problems

As a result of intensive research into the structure of a piston of the three-ring type, the inventors found that, in addition to an oil-drain hole for discharging lubricating oil scraped off by an oil ring to the inner space of the piston, an oil-drain hole disposed at a predetermined position for discharging lubricating oil scraped off by a second ring to the inner space of the piston achieves a marked effect, and the present invention was accordingly made.

The present invention will now be described below.

(1) A piston for an internal-combustion engine, three piston rings composed of two compression rings and one oil ring being assembled into the piston, the piston having an oil-drain hole communicating with the inner space of the piston formed in an oil-ring groove into which the oil ring is fitted, includes an oil-drain hole connected with a second-ring groove, the oil-drain hole having an opening spreading from the lower portion of the bottom of the second-ring groove in a top-to-bottom direction of the piston to the lower surface of the second-ring groove and linearly extending to the inner space of the piston.

(2) The piston for an internal-combustion engine according to (1) is characterized in that the oil-drain hole connected with the second-ring groove is inclined linearly downward to the inner space of the piston, the opening of the oil-drain hole spreading from the lower portion of the bottom of the second-ring groove in the top-to-bottom direction of the piston to the lower surface of the second-ring groove.

(3) The piston for an internal-combustion engine according to (1) is characterized in that the oil-drain hole connected with the second-ring groove spreads from the lower portion of the bottom of the second-ring groove in the top-to-bottom direction of the piston to the upper portion of a third land, and extends in a direction perpendicular to the top-to-bottom direction of the piston.

(4) The piston for an internal-combustion engine according to any one of (1) to (3) further includes another oil-drain hole connected with the second-ring groove, the opening of the oil-drain hole adjacent to the outer surface of the piston facing in the anti-thrust direction in addition to the oil-drain hole whose opening adjacent to the outer surface of the piston faces in the thrust direction.

(5) The piston for an internal-combustion engine according to (4) is characterized in that the oil-drain holes connected with the second-ring groove are disposed such that the openings of the oil-drain holes adjacent to the outer surface of the piston are symmetrical with respect to the center of a pin shaft.

(6) A piston for an internal-combustion engine, three piston rings composed of two compression rings and one oil ring being assembled into the piston, the piston having an oil-drain hole communicating with the inner space of the piston formed in an oil-ring groove into which the oil ring is fitted, includes an oil-drain hole connected with a second-ring groove, the oil-drain hole having an opening spreading from the lower surface of the second-ring groove to the upper portion of a third land and extending to the inner space of the piston while being inclined linearly downward.

(7) The piston for an internal-combustion engine according to (6) further includes another oil-drain hole connected with the second-ring groove, the opening of the oil-drain hole adjacent to the outer surface of the piston facing in the anti-thrust direction in addition to the oil-drain hole whose opening adjacent to the outer surface of the piston faces in the thrust direction.

(8) The piston for an internal-combustion engine according to (7) in characterized in that the oil-drain holes connected with the second-ring groove are disposed such that the openings of the oil-drain holes adjacent to the outer surface of the piston are symmetrical with respect to the center of a pin shaft.

(9) A combination of a piston and piston rings for an internal-combustion engine, three piston rings composed of two compression rings and one oil ring being assembled into the piston, is characterized in that the piston includes an oil-drain hole communicating with the inner space of the piston formed in an oil-ring groove into which the oil ring is fitted, and an oil-drain hole connected with a second-ring groove, the oil-drain hole having an opening spreading from the lower portion of the bottom of the second-ring groove in a top-to-bottom direction of the piston to the lower surface of the second-ring groove and linearly extending to the inner space of the piston; and that a ratio S1/d1 of an end gap S1 to a nominal diameter d1 of a first ring serving as a compression ring is set in the range from 0.002 to 0.004, and a ratio S1/d1 of an end gap S1 to a nominal diameter d1 of a second ring is set in the range from 0.0030 to 0.0096.

(10) A combination of a piston and piston rings for an internal-combustion engine, three piston rings composed of two compression rings and one oil ring being assembled into the piston, is characterized in that the piston includes an oil-drain hole communicating with the inner space of the piston formed in an oil-ring groove into which the oil ring is fitted, and an oil-drain hole connected with a second-ring groove, the oil-drain hole having an opening spreading from the lower surface of the second-ring groove to the upper portion of a third land and extending to the inner space of the piston while being inclined linearly downward; and that a ratio S1/d1 of an end gap S1 to a nominal diameter d1 of a first ring serving as a compression ring is set in the range from 0.002 to 0.004, and a ratio S1/d1 of an end gap S1 to a nominal diameter d1 of a second ring is set in the range from 0.0030 to 0.0096.

Advantages

According to the present invention, when the engine is operated after inserting the piston rings into the corresponding ring grooves and assembling the piston into the cylinder, the lubricating oil scraped off by the oil ring can be discharged to the inner space of the piston through the oil-drain hole connected with the oil-ring groove, and at the same time, the lubricating oil scraped off by the second ring can be quickly discharged to the inner space of the piston through the hole connected with the second-ring groove.

Thus, the piston of the three-ring type according to the present invention can sufficiently control the consumption of the lubricating oil when the pressure inside the combustion chamber becomes negative, for example, during intake strokes of the engine or during use of engine braking.

### BRIEF DESCRIPTION OF THE DRAWINGS

FIG. 1 is a schematic partial longitudinal sectional view illustrating the structure of a piston of the three-ring type according to a first embodiment.

FIG. 2 is a schematic partial longitudinal sectional view illustrating the piston of the three-ring type according to the first embodiment assembled into a cylinder.

FIGS. 3(a) to 3(c) are schematic views illustrating actions of the piston according to the first embodiment during acceleration or constant-speed driving.

FIGS. 4(a) and 4(b) are schematic views illustrating actions of the piston according to the first embodiment during deceleration.

FIGS. 5(a) and 5(b) are schematic partial longitudinal sectional views of pistons of the three-ring type according to a second embodiment and a third embodiment, respectively.

FIG. 6 is a schematic view illustrating positions of oil-drain holes 9 formed in pistons according to examples of the present invention along the circumferential direction of the pistons.

FIG. 7 is a schematic view illustrating positions of oil-drain holes 8 formed in the pistons according to examples of the present invention along the circumferential direction of the pistons.

FIG. 8 is a graph illustrating effects of the pistons according to the examples of the present invention.

FIG. 9(a) is a schematic partial longitudinal sectional view illustrating the structure of a known piston of the three-ring type, and FIG. 9(b) is a schematic view illustrating the problem of the piston.

FIG. 10 is a schematic partial longitudinal sectional view illustrating the structure of a piston of the three-ring type according to Comparative Example 1.

FIG. 11 is a schematic partial longitudinal sectional view illustrating the structure of a piston of the three-ring type according to Comparative Example 2.

FIG. 12 illustrates the thickness a1 and the width h1 of a piston ring.

FIG. 13 illustrates the end gap S1 and the nominal diameter d1 of the piston ring.

### REFERENCE NUMERALS

1 top portion of a piston
2 first-ring groove
3 second-ring groove
4 oil-ring groove
5 second land
6 third land
7 skirt portion
8, 9, 19, 29, 49, 59 oil-drain holes
10A top-to-bottom direction of the piston
10B, 10C, 10D, 10E, 10F, 10G, 10H moving directions of the piston
11 cylinder
12 first ring
13 second ring
14 oil ring
15 thrust direction
16 center of a pin shaft
α1, α2 angles
θ1, θ2, θ3, θ4 angles
a1 thickness of a ring
h1 width of the ring
S1 end gap
d1 nominal diameter of the ring
20 upper surface of the second-ring groove
21 bottom of the second-ring groove
22 lower surface of the second-ring groove
X direction toward the outer surface of the piston
Y direction toward the inner surface of the piston
Z inner space of the piston

### BEST MODE FOR CARRYING OUT THE INVENTION

Pistons of the three-ring type according to the present invention, which is applied to four-stroke gasoline engines, will now be described with reference to the drawings.

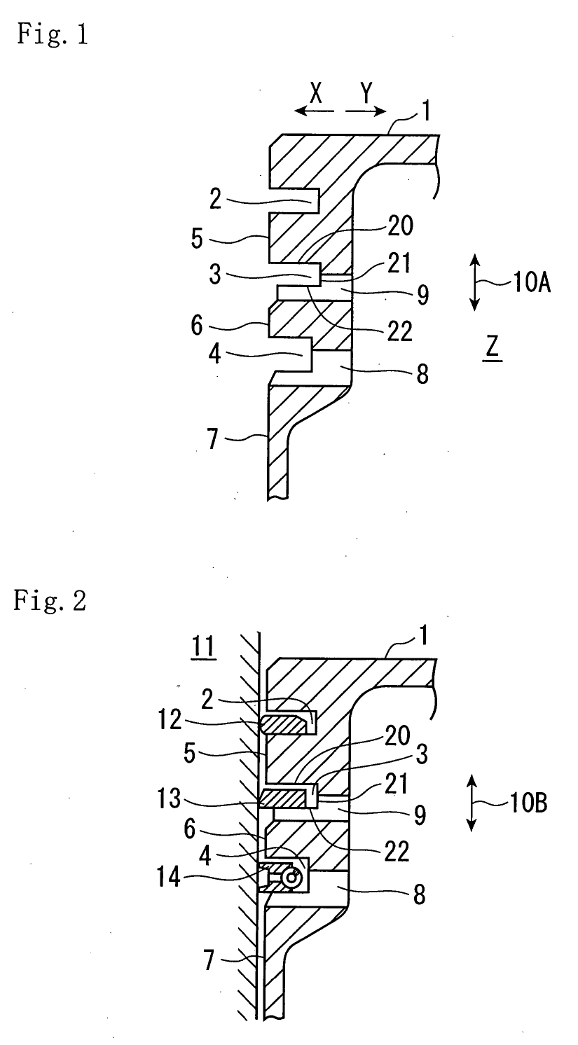

FIG. 1 is a partial longitudinal sectional view schematically illustrating the structure of a piston of the three-ring type according to a first embodiment, and FIG. 2 is a partial longitudinal sectional view schematically illustrating the piston of the three-ring type according to the first embodiment assembled into a cylinder 11.

As shown in the schematic partial longitudinal sectional view in FIG. 1, the piston of the three-ring type according to the first embodiment has a first-ring groove 2, a second-ring groove 3, and an oil-ring groove 4 disposed in this order from the top to bottom on an outer periphery of a top portion 1 thereof. The top portion 1 of the piston of the three-ring type further includes a second land 5 disposed under the first-ring groove 2, and a third land 6 disposed under the second-ring groove 3. In FIG. 1, reference numerals 7 and 10A denote a skirt portion and a top-to-bottom direction of the piston, respectively. Moreover, reference numerals 20, 21, and 22 denote the upper surface, the bottom, and the lower surface of the second-ring groove, respectively. Reference marks X, Y, and Z denote a direction toward the outer surface of the piston, a direction toward the inner surface of the piston, and an inner space of the piston, respectively. The inner space Z of the piston shown in FIG. 1 indicates a space where a connecting rod (not shown) is located.

The piston shown in FIG. 1 includes no oil-jetting means for cooling the interior thereof. When the piston includes oil-jetting means, for example, lubricating oil can enter oil-drain holes 8 and 9 from the inner space Z of the piston depending on positions to which oil jet is impinged, and can flow backward in the direction X toward the outer surface of the piston. Thus, the oil-jetting positions need to be set such that oil is not splashed on the oil-drain holes 8 and 9.

As shown in FIG. 2, the piston of the three-ring type according to the first embodiment includes a first ring 12, a second ring 13, and an oil ring 14 fitted into the corresponding ring grooves 2, 3, and 4, respectively, and is installed in the cylinder 11.

Herein, as shown in FIG. 1, the piston of the three-ring type according to the first embodiment is characterized in that it has the oil-drain hole 9, which is a through-hole, connected with the second-ring groove 3 and extending to the inner space of the piston in a direction perpendicular to the top-to-bottom direction of the piston such that the oil-drain hole 9 spreads from the lower portion regarding the top-to-bottom direction of the piston, of the bottom 21 of the second-ring groove to the upper portion of the third land 6 in addition to the oil-drain hole 8 connected with the oil-ring groove 4.

Moreover, as shown in FIG. 2, the oil-drain hole 8 connected with the oil-ring groove 4 is a hole that communicates with the inner space of the piston as in those of the existing pistons of the three-ring type, and excess lubricating oil scraped by the oil ring 14 is returned to an oil pan through the hole while the piston reciprocates in a moving direction 10B.

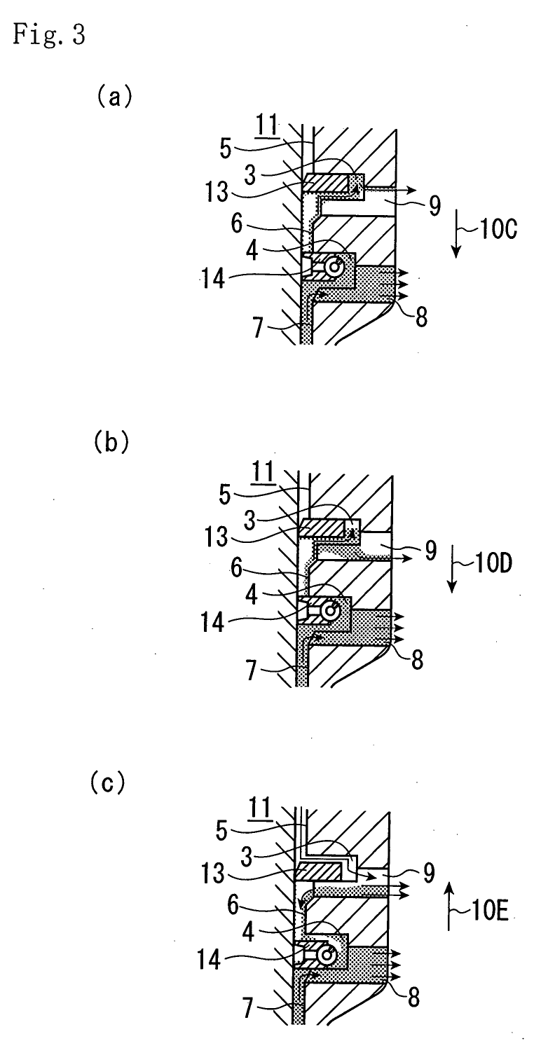

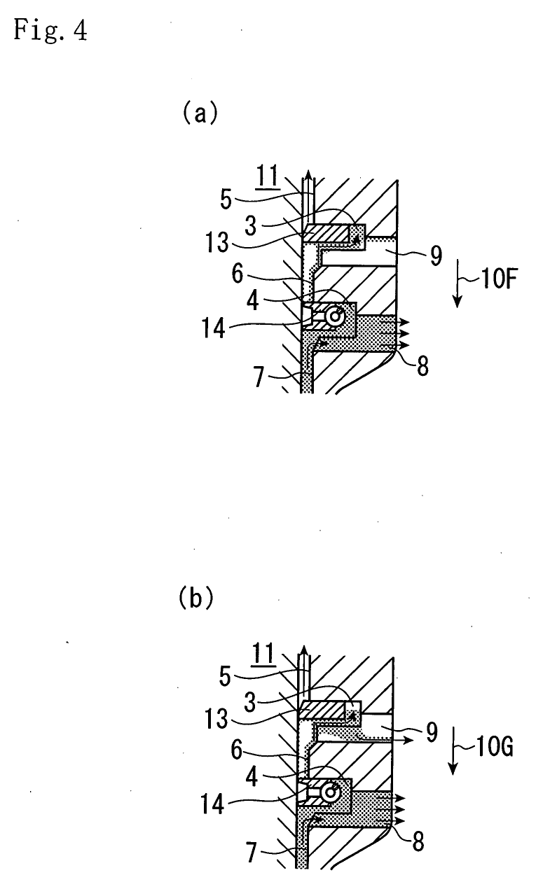

Actions of the piston of the three-ring type according to the first embodiment (FIG. 2) will now be described in detail with reference to schematic views in FIGS. 3 and 4.

Since the oil-drain hole 9 connected with the second-ring groove 3 spreads from the lower portion regarding the top-to-bottom direction of the piston, of the bottom 21 of the second-ring groove to the upper portion of the third land 6 and extends in the direction perpendicular to the top-to-bottom direction of the piston, the following effects can be accomplished.

FIGS. 3 and 4 schematically illustrate states where the lubricating oil raised to the position of the second ring 13 is discharged from the oil-drain hole 9 connected with the second-ring groove 3 during acceleration when the engine speed is increased or during constant-speed driving when the engine speed is constant. For ease of explanation, only the part of the second ring 13 and the oil ring 14 is illustrated.

FIGS. 3(a) and 3(b) illustrate a first half and a second half, respectively, of an intake stroke.

In FIG. 3(a) illustrating the first half of the intake stroke, the piston is accelerated in a moving direction 10C, and the second ring 13 and the oil ring 14 are made to contact the upper surfaces of the corresponding ring grooves by action of the inertial force. The lubricating oil supplied from the skirt portion 7 to the oil ring 14 is scraped off by the oil ring 14, and most of the lubricating oil is discharged from the oil-drain hole 8 in the oil-ring groove 4. However, a small amount of the lubricating oil passes across the oil ring 14 and moves upward to the third land 6. Since the direction of the inertial force is upward in FIG. 3(a), the lubricating oil on the third land 6 enters the second-ring groove 3. However, the excess lubricating oil is quickly discharged through the oil-drain hole 9 to the inner space of the piston. In FIG. 3(b) illustrating the second half of the intake stroke, the piston is moving in a moving direction 10D. Since the direction of the inertial force is downward, the lubricating oil inside the second-ring groove 3 flows downward, and is quickly discharged through the oil-drain hole 9.

FIG. 3(c) schematically illustrates an action of the piston during a compression stroke. The piston is accelerated in a moving direction 10E, and the second ring 13 and the oil ring 14 are made to contact the lower surfaces of the corresponding ring grooves. At this time, gas leaked from the end gap of the first ring 12 enters the second land 5 in response to an increase in pressure inside the cylinder. However, most of the gas is discharged from the oil-drain hole 9 inside the second-ring groove 3, and thus the lubricating oil inside the second-ring groove 3 in the vicinity of the oil-drain hole 9 and the lubricating oil inside the oil-drain hole 9 are discharged to the inner space of the piston in accordance with the gas flow.

Next, an action of the piston according to the first embodiment when the engine rotating at a high speed is decelerated using strong engine braking will be described with reference to FIG. 4.

FIGS. 4(a) and 4(b) illustrate a first half and a second half, respectively, of an intake stroke. When an engine rotating at a constant high speed is decelerated using strong engine braking, a negative pressure lower than atmospheric pressure is generated inside the combustion chamber during a period from the intake stroke to a predetermined point in a compression stroke and during a second half of an expansion stroke.

Therefore, the negative pressure inside the cylinder also slightly acts on the second land 5 both during the first half (FIG. 4(a)) and the second half (FIG. 4(b)) of the intake stroke, and thus the second ring 13 is in contact with the upper surface so as to adhere to the upper surface by the negative pressure. Since the pressure around the third land 6 is similar to that inside the piston (close to atmospheric pressure) due to the oil-drain hole 9, lubricating oil sucked from the periphery of the oil ring 14 is reduced, and thus the lubricating oil raised to the third land 6 is reduced.

Moreover, as shown in FIG. 4(a), the lubricating oil passing by the oil ring 14 and entering the third land 6 according to the upward inertial force is quickly discharged from the oil-drain hole 9 connected with the second-ring groove 3. Furthermore, as shown in FIG. 4(b), the lubricating oil inside the second-ring groove 3 flows downward according to the downward inertial force, and is quickly discharged from the oil-drain hole 9.

With the improvement of the check-valve effect of the second ring 13 and the reduction in the amount of the lubricating oil sucked from the periphery of the oil ring 14 according to the flow caused by the negative pressure, the consumption of the lubricating oil can be sufficiently controlled under operating conditions where a large negative pressure acts inside the cylinder.

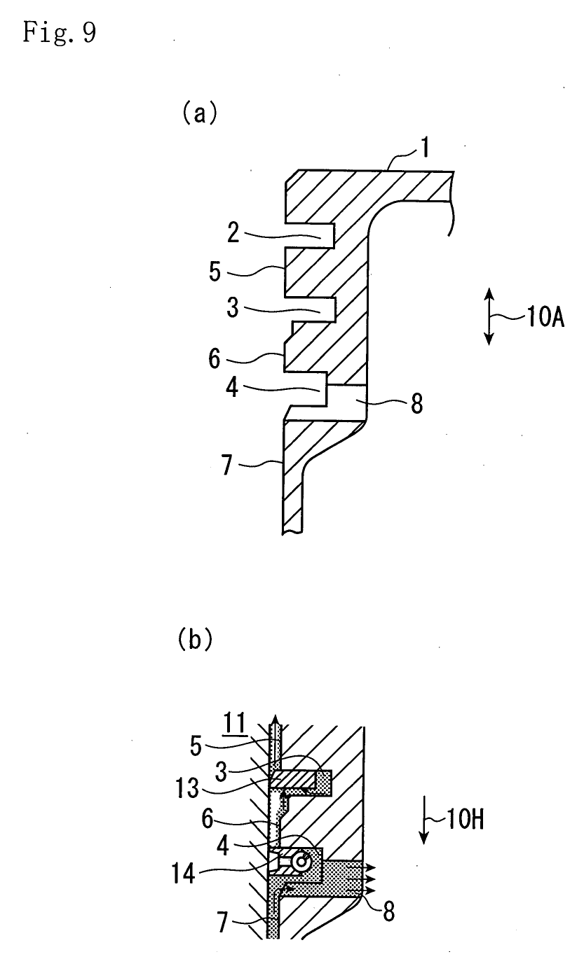

In contrast, in the case of the existing piston of the three-ring type shown in FIG. 9(b) having no oil-drain hole 9 connected with the second-ring groove 3 and communicating with the inner space of the piston, the lubricating oil raised to the position of the third land 6 under a condition where the pressure inside the combustion chamber is lower than atmospheric pressure and the lubricating oil scraped off by the second ring 13 are sucked upward mainly through the end gap of the second ring 13. Therefore, when the existing piston of the three-ring type is installed in an engine, the consumption of the lubricating oil is significantly increased as the pressure inside the combustion chamber becomes lower than atmospheric pressure.

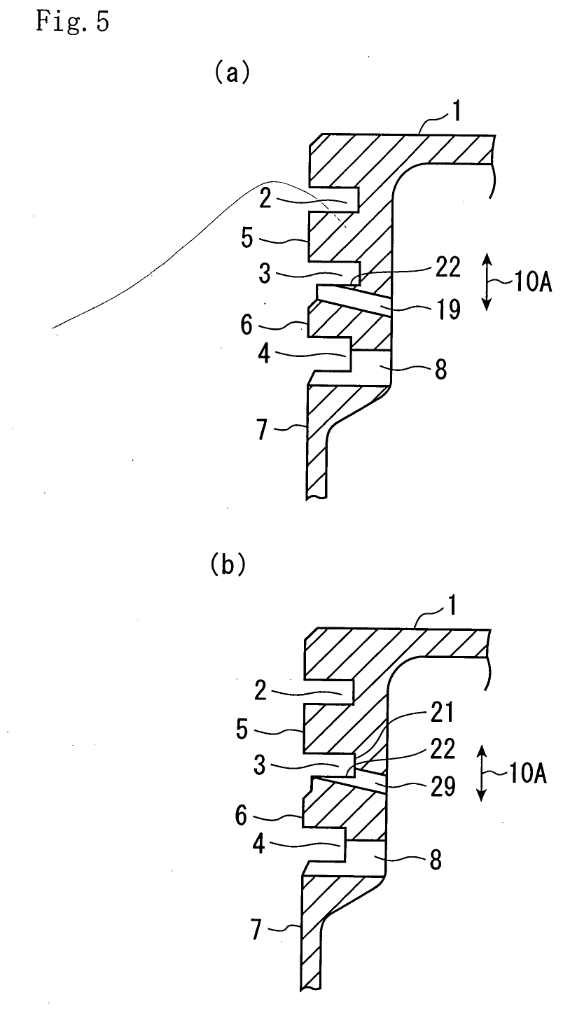

The oil-drain hole 9 connected with the second-ring groove 3 can be formed at positions of oil-drain holes 19 and 29 shown in FIGS. 5(a) and 5(b), respectively.

The oil-drain hole 19 connected with the second-ring groove 3 shown in FIG. 5(a) is a through-hole having an opening spreading from the lower surface 22 of the second-ring groove to the upper portion of the third land 6, and is linearly inclined downward to the inner space of the piston so as to communicate with the inner space of the piston. As shown in FIG. 2, the lower surface 22 of the second-ring groove faces the lower surface of the second ring 13 when the second ring 13 is fitted into the groove.

The same effect as that of the piston of the three-ring type according to the first embodiment can be accomplished with the piston of the three-ring type according to a second embodiment having the oil-drain hole 19 connected with the second-ring groove 3, since it also has a through-hole having an opening in the lower surface of the second-ring groove and linearly extending downward to the inner space of the piston.

Moreover, as shown in FIG. 5(b), the piston of the three-ring type according to a third embodiment has the oil-drain hole 29 connected with the second-ring groove 3, the oil-drain hole 29 having an opening spreading from the lower portion regarding the top-to-bottom direction of the piston, of the bottom 21 of the second-ring groove to the lower surface 22 of the second-ring groove and inclined downward to the inner space of the piston. As shown in FIG. 2, the bottom 21 of the second-ring groove faces the rear surface of the second ring 13 when the second ring 13 is fitted into the groove.

As described above, the piston of the three-ring type according to the present invention has the oil-drain hole, which is a through-hole, connected with the second-ring groove 3, the oil-drain hole having an opening in the lower surface of the second-ring groove and linearly extending to the inner space of the piston. The linear through-hole can be easily machined, and oil can be quickly discharged therethrough.

Therefore, according to the piston of the three-ring type of the present invention, as is confirmed with the below-mentioned examples, the consumption of the lubricating oil can be sufficiently controlled compared with that of the existing pistons due to the effect of quick discharge of the lubricating oil scraped off by the second ring 13 through the oil-drain hole connected with the second-ring groove 3 under a condition where the pressure inside the combustion chamber becomes negative, for example, during intake strokes of the engine or during use of engine braking.

In this case, the diameter of the oil-drain hole connected with the second-ring groove 3 is set to 0.1 mm or larger such that the lubricating oil scraped off by the second ring 13 is smoothly discharged, and two or more oil-drain holes 9 having such a diameter connected with the second-ring groove 3 are preferably provided in the piston in the circumferential direction thereof.

Moreover, in addition to the oil-drain hole 9 having an opening adjacent to the outer surface of the piston facing in the thrust direction of the piston, the piston of the three-ring type according to the present invention preferably has an oil-drain hole 9 connected with the second-ring groove 3 having an opening adjacent to the outer surface of the piston facing in the anti-thrust direction thereof.

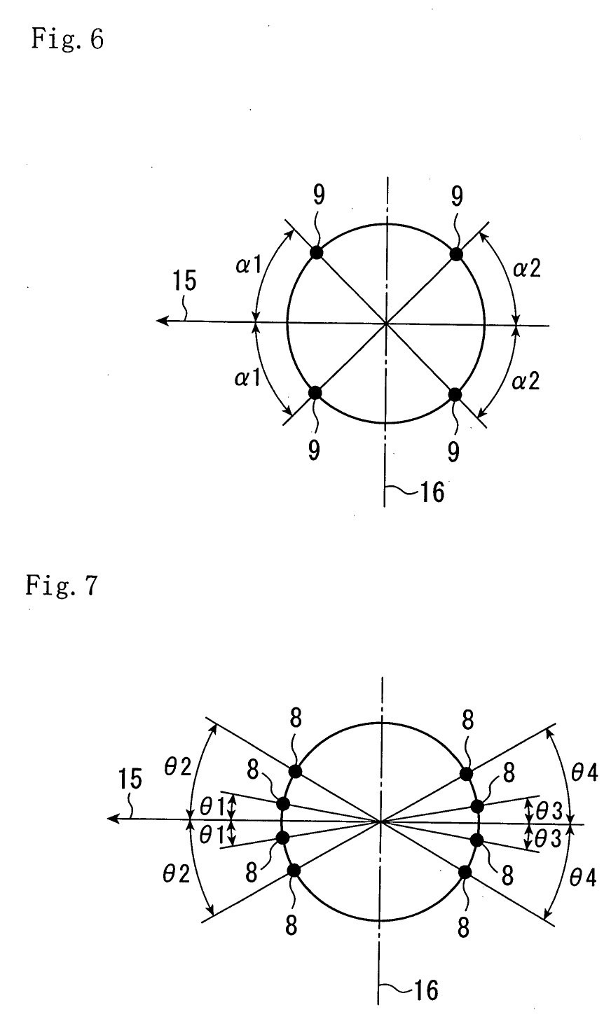

Moreover, the piston of the three-ring type preferably has two or more oil-drain holes 9 connected with the second-ring groove 13 symmetrically positioned with respect to the center 16 of a pin shaft. FIG. 6 illustrates positions of the oil-drain holes 9 connected with the second-ring groove 3 formed in pistons according to Examples 1 and 2 (described below) of the present invention along the circumferential direction of the pistons. In FIG. 6, a reference numeral 15 denotes the thrust direction.

According to the piston of the three-ring type having the oil-drain holes 9 connected with the second-ring groove 3, openings of the oil-drain holes 9 adjacent to the outer surface of the piston preferably disposed symmetrically with respect to the center 16 of the pin shaft, the lubricating oil scraped off by the second ring 13 can be quickly discharged through the holes connected with the second-ring groove 3 symmetrically with respect to the center 16 of the pin shaft and uniformly in the circumferential direction of the piston. Moreover, the holes connected with the second-ring groove 3, the openings of the holes adjacent to the outer surface of the piston symmetrically disposed with respect to the center 16 of the pin shaft, can be easily machined with advantage.

Moreover, the above-described piston of the three-ring type according to the present invention can be used in combination with a first ring 12, serving as a compression ring, having a ratio S1/d1 of an end gap S1 to a nominal diameter d1 in the range of 0.002 to 0.004 and a second ring 13 having a ratio S1/d1 of an end gap S1 to a nominal diameter d1 in the range of 0.0030 to 0.0096.

FIG. 13 illustrates the end gap S1 and the nominal diameter d1 of the second ring 13. The reference symbols S1 and d1 also denote the same portions of the first ring 12.

The ratio S1/d1 of the end gap S1 to the nominal diameter d1 of the first ring 12 is set to be in the range of 0.002 to 0.004 since volume of blow-by gas can be disadvantageously increased when S1/d1 exceeds 0.004 and since the end-gap portions can interfere with each other when S1/d1 is less than 0.002. Moreover, the ratio S1/d1 of the end gap S1 to the nominal diameter d1 of the second ring 13 is set to be in the range of 0.0030 to 0.0096 since consumption of lubricating oil can be disadvantageously increased during deceleration or during high-speed driving with a light load when S1/d1 exceeds 0.0096 and since the consumption of the lubricating oil can be disadvantageously increased during medium- to high-speed driving with a high load when S1/d1 is less than 0.0030.

In short, when the piston of the three-ring type according to the present invention is used in combination with the first ring 12 and the second ring 13 having the ratios S1/d1 of the end gaps S1 to the nominal diameters d1 in the above-described ranges, the volume of the blow-by gas is not increased, the possibility of the interference of the end-gap portions can be reduced, and the consumption of the lubricating oil can be sufficiently controlled compared with the existing pistons of the three-ring type having no oil-drain holes 9 connected with the second-ring grooves 3 communicating with the inner spaces of the pistons even when the pressure inside the combustion chamber becomes negative, for example, during intake strokes of the engine or during use of engine braking.

Moreover, the piston of the three-ring type according to the present invention can sufficiently control the consumption of the lubricating oil using either an oil ring 14 of the two-piece type including an oil-ring body and an expander, or an oil ring 14 of the three-piece type including two side rails and a space expander. The two-piece type not having sealing property in the groove of the piston ring in the axial direction can exhibit a more beneficial effect of controlling the consumption of the lubricating oil than the three-piece type having sealing property in the axial direction when it is assembled into the piston according to the present invention.

Moreover, the piston of the three-ring type according to the present invention exhibits a more beneficial effect of controlling the consumption of the lubricating oil when it is used in combination with rings, composed of two compression rings and one oil ring, having a total tension ratio in the range of 0.2 to 0.6 N/mm, the total tension ratio being determined by dividing the total tension of the two compression rings and the oil ring by the diameter of the cylinder bore.

### EXAMPLES

Piston rings having specifications of a1, h1, and S1 shown in Table 1 were attached to the pistons of the three-ring type shown in FIG. 1 such that the total tension ratio determined by dividing the total tension of the three rings by the bore diameter was set to 0.38 N/mm, and the pistons were assembled into the cylinders 11. Then, consumption of lubricating oil and volume of blow-by gas during acceleration and deceleration were determined. The test engine was an inline four-cylinder water-cooled four-stroke gasoline engine having a bore diameter of 86 mm, a stroke of 86 mm, and a displacement of 1,998 cc.

TABLE 1

| | First ring | | | Second ring | | | Oil ring | | |
|---|---|---|---|---|---|---|---|---|---|
| | | Thick- | End | | Thick- | End | | Thick- | End |
| | Width | ness | gap | Width | ness | gap | Width | ness | gap |
| | h1 | a1 | S1 | h1 | a1 | S1 | h1 | a1 | S1 |
| Example 1 | 1.2 | 2.9 | 0.20 | 1.2 | 3.3 | 0.35 | 2.0 | 2.5 | 0.2 |
| Example 2 | 1.2 | 2.9 | 0.30 | 1.2 | 3.3 | 0.55 | 2.0 | 2.5 | 0.2 |
| Example of | 1.2 | 2.9 | 0.30 | 1.2 | 3.3 | 0.55 | 2.0 | 2.5 | 0.2 |
| Related Art | | | | | | | | | |
| Comparative | 1.2 | 2.9 | 0.30 | 1.2 | 3.3 | 0.55 | 2.0 | 2.5 | 0.2 |
| Example 1 | | | | | | | | | |
| Comparative | 1.2 | 2.9 | 0.30 | 1.2 | 3.3 | 0.55 | 2.0 | 2.5 | 0.2 |
| Example 2 | | | | | | | | | |

| | | | |
|---|---|---|---|
| Specification | Sliding surface: | Sliding surface: | Configuration: |
| | barrel-shaped | tapered | two-piece type |
| | | Width of sliding | (coil expander and |
| | | surface: 0.3 mm | oil ring body) |
| | | | Width of rail: |
| | | | 0.2 mm (two rails) |

In Examples 1 and 2 of the present invention, four oil-drain holes 9 connected with the second-ring groove 3 were disposed as shown in FIG. 6 such that the openings thereof adjacent to the outer surface of the piston were symmetrical with respect to the center 16 of the pin shaft and such that angles α1 and α2 became 45° in addition to the oil-drain holes 8 connected with the oil-ring groove 4. The oil-drain holes 9 connected with the second-ring groove 3 had a diameter of 1.5 mm, and linearly extended in a direction perpendicular to the top-to-bottom direction of the piston so as to spread from the lower portion regarding the top-to-bottom direction, of the bottom of the second-ring groove of the piston to the upper portion of the third land.

Moreover, eight oil-drain holes 8 connected with the oil-ring groove 4, four at the thrust side and the other four at the anti-thrust side, were disposed as shown in FIG. 7 such that the openings adjacent to the outer surface of the piston were symmetrical with respect to the center 16 of the pin shaft and such that angles θ1 and θ3 became 10° and θ2 and θ4 became 30°. The diameter of the oil-drain holes 8 connected with the oil-ring groove 4 was set to 2.0 mm.

The end gaps S1 in Example 1 were smaller than those in Example 2. Example 2 was identical to Example 1 other than this.

The test engine was operated according to a driving pattern having acceleration, constant-speed driving, and deceleration in combination. The number of revolutions of the engine ranged from 1,000 to 4,000 per minute. The value of the negative pressure was set by controlling the pressure inside the intake pipe using strong engine braking. The duration of deceleration was set so as to be constant, and the mean value of the negative pressure inside the intake pipe during deceleration was set to an arbitrary value for evaluation.

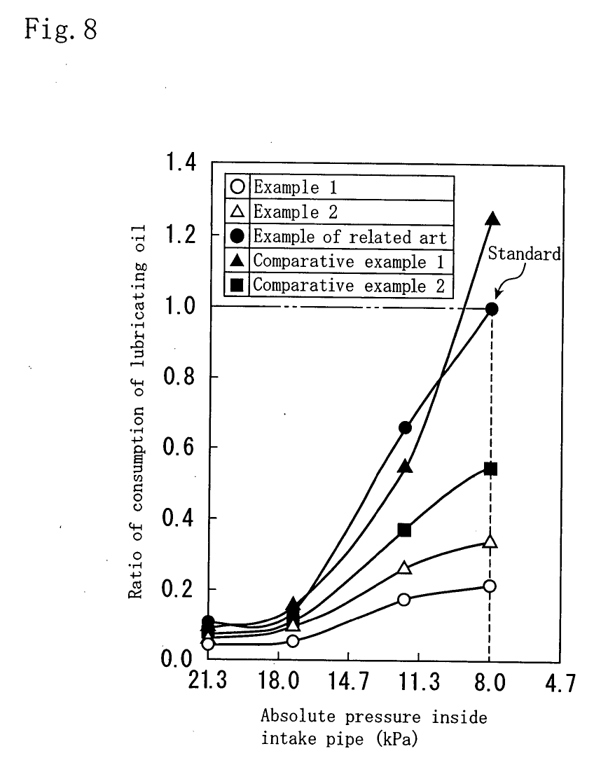

FIG. 8 is a graph whose abscissa represents the value of the negative pressure and whose ordinate represents the ratio of consumption of the lubricating oil under the condition. The ratio of consumption of the lubricating oil was scaled by defining the consumption of the lubricating oil in an example of the related art obtained when the engine was operated such that the absolute pressure inside the intake pipe became 8.0 kPa as unity.

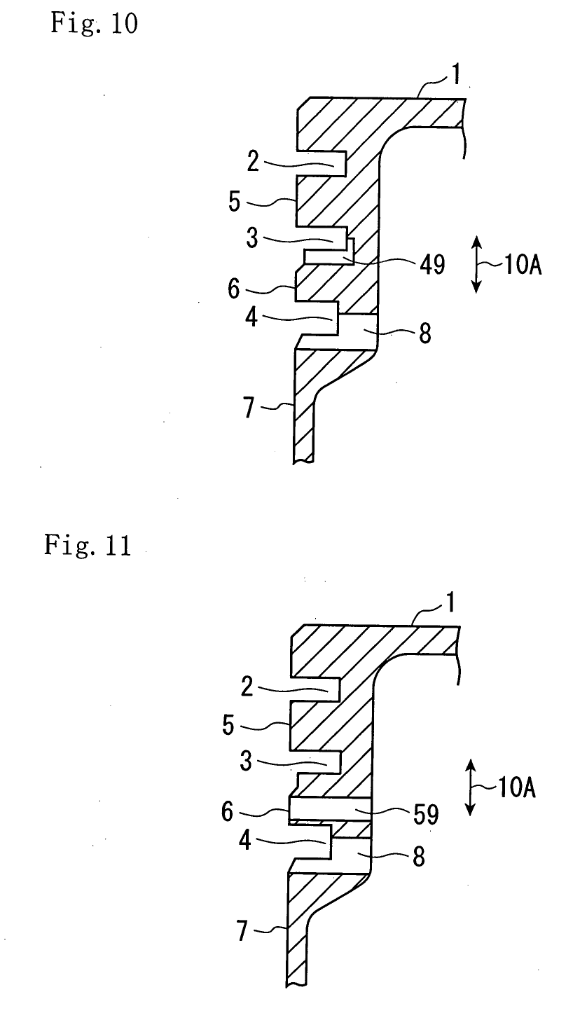

In the example of the related art, piston rings identical to those in Example 2 were attached to the piston of the three-ring type shown in FIG. 9(a). The piston was then assembled into the cylinder of the test engine, and tested in the same manner. In Comparative Example 1, piston rings identical to those in Example 2 were attached to the piston of the three-ring type shown in FIG. 10 having oil-drain holes 49 extending only to predetermined positions in the top portion 1 of the piston. In Comparative Example 2, piston rings identical to those in Example 2 were attached to a piston of the three-ring type shown in FIG. 11 having oil-drain holes 59 formed in an intermediate portion regarding the top-to-bottom direction, of the third land 6. These pistons were tested in the same manner after being assembled into the cylinder of the test engine.

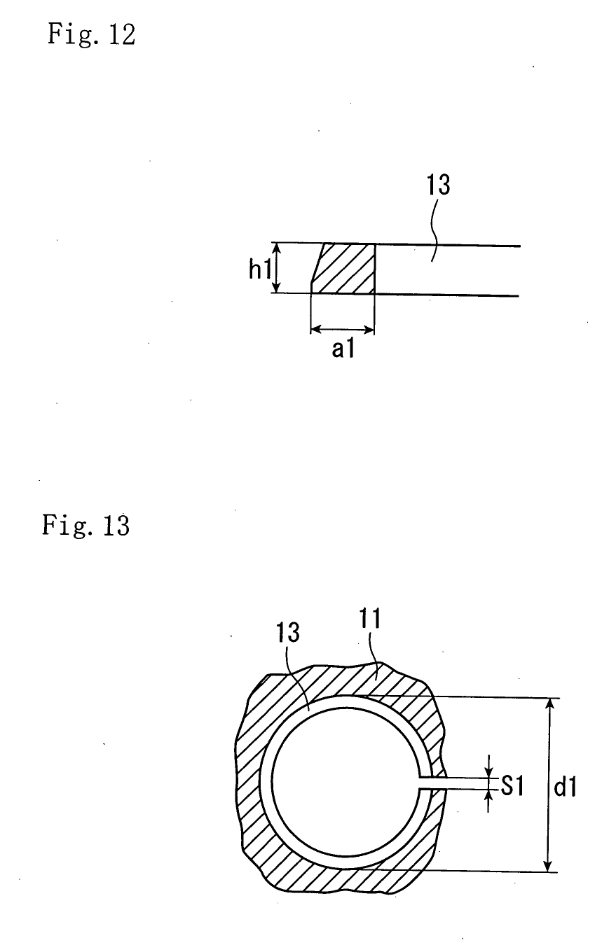

FIG. 12 illustrates the dimensions a1 and h1 of the second ring 13, and FIG. 13 illustrates the definitions of the end gap S1 and the nominal diameter d1 of the second ring 13 as a representative.

With reference to FIG. 8 illustrating the effect of reducing the consumption of the lubricating oil, the engine having the pistons according to Example 1 or 2 installed therein was able to sufficiently control the consumption of the lubricating oil compared with the case of the example of the related art when the pressure inside the combustion chambers became negative, for example, during intake strokes of the engine or during use of engine braking. In this case, the consumption of the lubricating oil was sufficiently controlled compared with Comparative Example 2 having the oil-drain holes formed only in the intermediate portion regarding the top-to-bottom direction, of the third land.

Moreover, when Examples 1 and 2 are compared, Example 1 in which the ratio S1/d1 of the end gap S1 to the nominal diameter d1 of the first ring 12 was 0.0023 and S1/d1 of the second ring 13 was 0.0041 exhibited a more beneficial effect of controlling the consumption of the lubricating oil than Example 2 in which S1/d1 was outside the preferable range of the present invention when the pressure inside the combustion chambers became negative, for example, during intake strokes of the engine or during use of engine braking.

In contrast, Comparative Example 1 exhibited an insufficient effect of controlling the consumption of the lubricating oil since the oil on the third land was not discharged.

In Examples 1 and 2, the piston shown in FIG. 1 was used. However, the pistons shown in FIGS. 5(a) and 5(b) also achieved the same results. The ratio of consumption of the lubricating oil was in the range of 0.18 to 0.35 when the absolute pressure inside the intake pipe was 8.0 kPa. Thus, the combination of the piston and the piston rings according to the present invention can produce a beneficial effect of controlling the consumption of the lubricating oil.

1. A piston for an internal-combustion engine, three piston rings composed of two compression rings and one oil ring being assembled into the piston, the piston having an oil-drain hole communicating with the inner space of the piston formed in an oil-ring groove into which the oil ring is fitted, comprising:
an oil-drain hole connected with a second-ring groove, the oil-drain hole having an opening spreading from the lower portion of the bottom of the second-ring groove in a top-to-bottom direction of the piston to the lower surface of the second-ring groove and linearly extending to the inner space of the piston.

2. The piston for an internal-combustion engine according to claim 1, wherein the oil-drain hole connected with the second-ring groove is inclined linearly downward to the inner space of the piston, the opening of the oil-drain hole spreading from the lower portion of the bottom of the second-ring groove in the top-to-bottom direction of the piston to the lower surface of the second-ring groove.

3. The piston for an internal-combustion engine according to claim 1, wherein the oil-drain hole connected with the second-ring groove spreads from the lower portion of the bottom of the second-ring groove in the top-to-bottom direction of the piston to the upper portion of a third land, and extends in a direction perpendicular to the top-to-bottom direction of the piston.

4. The piston for an internal-combustion engine according to claim 1, further comprising:
another oil-drain hole connected with the second-ring groove, the opening of the oil-drain hole adjacent to the outer surface of the piston facing in the anti-thrust direction in addition to the oil-drain hole whose opening adjacent to the outer surface of the piston faces in the thrust direction.

5. The piston for an internal-combustion engine according to claim 4, wherein the oil-drain holes connected with the second-ring groove are disposed such that the openings of the oil-drain holes adjacent to the outer surface of the piston are symmetrical with respect to the center of a pin shaft.

6. A piston for an internal-combustion engine, three piston rings composed of two compression rings and one oil ring being assembled into the piston, the piston having an oil-drain hole communicating with the inner space of the piston formed in an oil-ring groove into which the oil ring is fitted, comprising:
an oil-drain hole connected with a second-ring groove, the oil-drain hole having an opening spreading from the lower surface of the second-ring groove to the upper portion of a third land and extending to the inner space of the piston while being inclined linearly downward.

7. The piston for an internal-combustion engine according to claim 6, further comprising:
another oil-drain hole connected with the second-ring groove, the opening of the oil-drain hole adjacent to the outer surface of the piston facing in the anti-thrust direction in addition to the oil-drain hole whose opening adjacent to the outer surface of the piston faces in the thrust direction.

8. The piston for an internal-combustion engine according to claim 7, wherein the oil-drain holes connected with the second-ring groove are disposed such that the openings of the oil-drain holes adjacent to the outer surface of the piston are symmetrical with respect to the center of a pin shaft.

9. A combination of a piston and piston rings for an internal-combustion engine, three piston rings composed of two compression rings and one oil ring being assembled into the piston, wherein
the piston includes an oil-drain hole communicating with the inner space of the piston formed in an oil-ring groove into which the oil ring is fitted, and an oil-drain hole connected with a second-ring groove, the oil-drain hole having an opening spreading from the lower portion of the bottom of the second-ring groove in a top-to-bottom direction of the piston to the lower surface of the second-ring groove and linearly extending to the inner space of the piston; and
a ratio S1/d1 of an end gap S1 to a nominal diameter d1 of a first ring serving as a compression ring is set in the range from 0.002 to 0.004, and a ratio S1/d1 of an end gap S1 to a nominal diameter d1 of a second ring is set in the range from 0.0030 to 0.0096.

10. A combination of a piston and piston rings for an internal-combustion engine, three piston rings composed of two compression rings and one oil ring being assembled into the piston, wherein
the piston includes an oil-drain hole communicating with the inner space of the piston formed in an oil-ring groove into which the oil ring is fitted, and an oil-drain hole connected with a second-ring groove, the oil-drain hole having an opening spreading from the lower surface of the second-ring groove to the upper portion of a third land and extending to the inner space of the piston while being inclined linearly downward; and
a ratio S1/d1 of an end gap S1 to a nominal diameter d1 of a first ring serving as a compression ring is set in the range from 0.002 to 0.004, and a ratio S1/d1 of an end gap S1 to a nominal diameter d1 of a second ring is set in the range from 0.0030 to 0.0096.

11. The piston for an internal-combustion engine according to claim 2, further comprising:
another oil-drain hole connected with the second-ring groove, the opening of the oil-drain hole adjacent to the outer surface of the piston facing in the anti-thrust direction in addition to the oil-drain hole whose opening adjacent to the outer surface of the piston faces in the thrust direction.

12. The piston for an internal-combustion engine according to claim 3, further comprising:
another oil-drain hole connected with the second-ring groove, the opening of the oil-drain hole adjacent to the outer surface of the piston facing in the anti-thrust direction in addition to the oil-drain hole whose opening adjacent to the outer surface of the piston faces in the thrust direction.
